(19) United States
(12) Patent Application Publication
(10) Pub. No.: US 2013/0303293 A1
(43) Pub. Date: Nov. 14, 2013

(54) METHOD FOR PRODUCING TORQUE-LIMITING SECURING DEVICES

(71) Applicants: Andreas Eckstein, Landsberg am Lech (DE); Mathias Goldt, Feldkirch (AT); Marc Schaeffer, Feldkirch-Nifels (AT); Joerg Appi, Buchs (CH); Arjen Detmer Dijkhuis, Feldkirch (AT)

(72) Inventors: Andreas Eckstein, Landsberg am Lech (DE); Mathias Goldt, Feldkirch (AT); Marc Schaeffer, Feldkirch-Nifels (AT); Joerg Appi, Buchs (CH); Arjen Detmer Dijkhuis, Feldkirch (AT)

(73) Assignee: Hilti Aktiengesellschaft, Schaan (LI)

(21) Appl. No.: 13/878,694

(22) PCT Filed: Aug. 23, 2011
(86) PCT No.: PCT/EP2011/064449

§ 371 Date: Jul. 30, 2013

(30) Foreign Application Priority Data
Oct. 11, 2010 (DE) 10 2010 042 260.6

(51) Int. Cl. F16B 31/02

(52) U.S. Cl. CPC F16B 31/021
USPC 470/8

(57) ABSTRACT

A method for the production of torque-limited fastening devices, which each have a first head element with a contact for a fastening tool, and a second head element that is joined to the first head element via a welded joint that shears off at a predefined limit torque, said method providing a plurality of first head elements and second head elements having the same geometry, and in each case, a first head element and a second head element are welded together in a welding process that creates the welded joint. At least two welding processes are carried out employing at least one different welding parameter, so that different limit torques can be obtained for parts having the same geometry. A fastening device on a concrete anchor.

The invention relates to a method for the production of torque-limited fastening devices, for instance, shear nuts or shear screws, which each have a first head element with contact means for a fastening tool, and a second head element that is joined to the first head element by means of a welded joint that shears off at a predefined limit torque. The production method provides a plurality of first head elements and second head elements having the same geometry, and in each case, a first head element and a second head element are welded together in a welding process that creates the welded joint.

### BACKGROUND

Shear nuts or shear screws having two head elements are known which are joined together by means of a welded joint. When these nuts or screws are put in place, a fastening tool is used to apply a torque onto the first head element, whereby, at the beginning of the fastening procedure, the torque is applied to the second head element via the welded joint. If a predefined limit torque is reached at the end of the fastening procedure, the first head element shears off from the second head element at the welded joint. This shearing-off limits the maximum torque that acts on the second head element.

Such a shear nut is disclosed, for example, in U.S. Pat. Appln. No. 2002/076295 A1. According to this publication provides, these two head elements are joined together by means of laser welding.

### SUMMARY OF THE INVENTION

It is an object of the present invention to provide a method for the production of torque-limited fastening devices so that it is possible to easily and inexpensively produce fastening devices having numerous different limit torques.

The present invention provides that at least two welding process are carried out employing at least one different welding parameter, so that different limit torques can be obtained for parts having the same geometry.

A basic idea of the invention can be seen in the fact that the limit torque is not established by varying the geometry of the parts, especially not by varying the shapes and dimensions of the head elements or the number of welding points. Rather, according to the invention, different limit torque geometries are obtained in that at least one welding parameter is varied. Since the welding parameters determine the break behavior of the welding point, a targeted modification of at least one welding parameter allows a targeted establishment of the maximum torque at which the two head elements shear off from each other. Therefore, the invention makes it possible to adapt the limit torques of the parts to the given requirements, without having to change the geometry of the intermediate products, that is to say, the head elements. Consequently, there is no need to laboriously adapt the production tools to different geometries. At the same time, inventory costs can be lowered since only one type of head element needs to be kept in stock.

If electric resistance welding is employed as the welding method, it is particularly preferred for at least two welding processes to be carried out employing a different welding voltage, so that different limit torques are obtained for parts having the same geometry. The welding voltage can be varied in a very simple manner. According to this embodiment, the at least one different welding parameter is the welding voltage. However, other welding parameters can also be different.

If electric resistance welding is employed as the welding method, it is alternatively or additionally advantageous for at least two welding processes to be carried out using a different welding current intensity, so that different limit torques are obtained for parts having the same geometry. Varying the welding current intensity translates into very good process control. According to this embodiment, the at least one different welding parameter is the welding current intensity. However, other welding parameters can also be different.

Moreover, it can be advantageous for at least two welding processes to be carried out using a different processing temperature, so that different limit torques are obtained for parts having the same geometry. According to this embodiment, the at least one different welding parameter is the processing temperature. However, other welding parameters can also be different. The processing temperature, as a determining parameter, can also be utilized when a non-electric welding method is used.

Another preferred embodiment lies in the fact that at least two welding processes are carried out using a different pretension between the head elements, so that different limit torques are obtained for parts having the same geometry. According to this embodiment, the at least one different welding parameter is the pretension that is present between each of the head elements that are to be joined during the welding. However, other welding parameters can also be different. Varying the pretension between the head elements that are to be welded together makes it possible to produce parts that exhibit a very broad limit torque range.

For instance, it can be provided that the torque-limited fastening devices are shear nuts. In this case, it can be advantageous for the first head element to have an external polygon and/or for the second head element to have an internal thread. The fastening devices, however, can also be, for example, shear screws. In this case, it can be advantageous for the first head element to have an external polygon and/or for the second head element to have a shank element with an external thread. The external polygon can especially be a hexagon.

When the fastening elements according to the invention are employed for anchors, especially for concrete anchors, it is possible to check the correct installation of the anchor without using a torque wrench since the correct tightening torque becomes evident when the welded joint shears off. The residues of the weld that remain on the second head element after the shearing-off makes it possible to subsequently identify the torque-limited fastening devices. These residues make it possible to check whether the requisite torque was applied, even long after the fastening element or the anchor has been installed, which is a helpful feature within the scope of inspection procedures.

Accordingly, the invention also encompasses the use of a torque-limited fastening device that has a first head element with contact means for a fastening tool, and a second head element that is joined to the first head element by means of a welded joint that shears off at a predefined limit torque, especially when made by means of a method according to the invention for installing an anchor, especially a concrete anchor.

### BRIEF DESCRIPTION OF THE DRAWINGS

The invention will be explained in greater detail below on the basis of preferred embodiments. The following is schematically shown:

FIG. 1: an embodiment of a torque-limited fastening device during the welding process according to the invention;

FIG. 2: a torque-limited fastening device according to the invention; and

FIG. 3: the fastening device from FIG. 2, after the limit torque has been reached.

### DETAILED DESCRIPTION

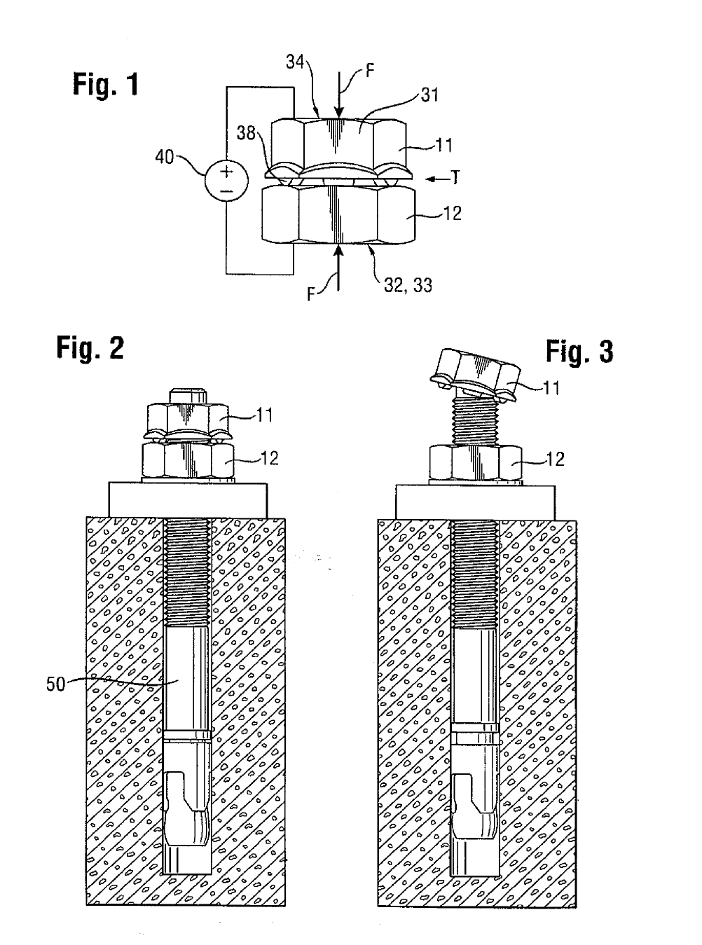

FIG. 1 schematically shows the production of a torque-limited fastening device according to the invention configured as a shear nut. The shear nut shown has a first head element 11 on whose outside there is an external polygon 31 configured as a hexagon onto which a turning tool can be placed. Moreover, the shear nut has a second head element 12 having a through hole 32 in which an internal thread 33 is configured. The first head element 11 likewise has a through hole 34 whose inside diameter, however, is larger than that of the internal thread 33 of the second head element 12, so that a threaded rod that matches the internal thread 33 of the second head element 12 can freely pass through the through hole 34 in the first head element 11. The face of the first head element 11 has foot elements 38 that project from the face of the first head element 11 and that serve to create a welded joint with the second head element 12. In the embodiment from FIG. 1, there are three foot elements 38 that each have the shape of a triangular prism.

As is shown in FIG. 1, when the fastening device with flush through holes 32 and 34 is produced, the two head elements 11 and 12 are arranged in such a way that the foot elements 38 of the first head element 11 rest on the second head element 12. For purposes of electric resistance welding, the two head elements 11 and 12 are joined with the opposite poles of a voltage source 40 and charged with an electric current. In this process, a welded joint is created between the two head elements 11 and 12 on the foot elements 38.

According to the invention, head elements 11 and 12 having the same geometry are used at all times. In order to nevertheless obtain fastening devices having different limit torques at the welded joint, different process parameters are selected during the welding. Thus, for instance, the voltage that is output by the voltage source 40 and/or the current that flows through the head elements 11 and 12 during the welding can be varied. Alternatively or additionally, the processing temperature T present at the welding point can be varied. As another alternative or in addition, the pretension, that is to say, the contact force F with which the head elements 11 and 12 are pressed together during the welding, can also be varied.

FIGS. 2 and 3 show the use of a fastening device produced according to the invention, comprising welded head elements 11 and 12 on an anchor 50. As can be seen in FIG. 2, the head elements 11 and 12 are joined together prior to the installation. As shown in FIG. 3, once the limit torque is reached, the first head element 11 onto which the torque has been applied shears off from the second head element 12, so that the second head element 12 is not tightened any further.

1-7. (canceled)

8: A method for the production of torque-limited fasteners, each fastener including a first head element with a contact for a fastening tool and a second head element joined to the first head element via a welded joint that shears off at a predefined limit torque, the method comprising:
providing a plurality of first head elements having a same first geometry and a plurality of second head elements having a same second geometry,
welding a first of the first head elements to a first of the second head elements using a first welding process to define a first fastener having a first limit torque; and
welding a second of the second head elements to a second of the second head elements using a second welding process employing at least one different welding parameter from the first welding process to define a second fastener having a second limit torque different from the first limit torque, the first and second fasteners having a same geometry.

9: The method as recited in claim 8 wherein the different welding parameter is a welding voltage.

10: The method as recited in claim 8 wherein the different welding parameter is a different welding current intensity.

11: The method as recited in claim 8 wherein the different welding parameter is a processing temperature.

12: The method as recited in claim 8 wherein the different welding parameter is a pretension between the first and second head elements.

13: The method as recited in claim 8 wherein the torque-limited fasteners are shear nuts, the first head element having an external polygon and/or the second head element having an internal thread.

14: A method for using of a torque-limited fastener having a first head element with a contact for a fastening tool, and a second head element joined to the first head element via a welded joint that shears off at a predefined limit torque, for installing an anchor.

15: The method as recited in claim 14 wherein the fastener is produced by the following method steps:
providing a plurality of first head elements having a same first geometry and a plurality of second head elements having a same second geometry, welding a first of the first head elements to a first of the second head elements using a first welding process to define a first fastener having a first limit torque; and
welding a second of the second head elements to a second of the second head elements using a second welding process employing at least one different welding parameter from the first welding process to define a second fastener having a second limit torque different from the first limit torque, the first and second fasteners having a same geometry.

16: The method as recited in claim 14 wherein the anchor is a concrete anchor.
